(19) United States
(12) Patent Application Publication
(10) Pub. No.: US 2021/0063223 A1
(43) Pub. Date: Mar. 4, 2021

(54) GAS METER

(71) Applicant: OMRON CORPORATION, Kyoto-shi (JP)

(72) Inventors: Hideyuki NAKAO, Kusatsu-shi (JP); Katsuyuki YAMAMOTO, Kusatsu-shi (JP); Takaaki SUZUMURA, Ritto-shi (JP); Makoto KAMEI, Otsu-shi (JP)

(73) Assignee: OMRON CORPORATION, Kyoto-shi (JP)

(21) Appl. No.: 16/985,419

(22) Filed: Aug. 5, 2020

(30) Foreign Application Priority Data
Aug. 30, 2019 (JP) 2019-158459

(51) Int. Cl. G01F 15/08; G01D 4/02

(52) U.S. Cl. CPC G01F 15/08; G01D 4/02

(57) ABSTRACT

A gas meter comprises a filter device having a filter for removing dust from gas that has flowed in from an inflow opening on the upstream side of a flow measurement module. The filter is disposed as to cover the inlet opening, and at least of a portion of the filter forms a plurality of filter partitions disposed spaced apart from one another toward the downstream side. At least two of the filter partitions have openings at different positions toward the downstream side.

### CROSS REFERENCE TO RELATED APPLICATIONS

This application claims priority to Japanese Patent Application No. 2019-158459, filed on Aug. 30, 2019. The entire disclosure of Japanese Patent Application No. 2019-158459 is hereby incorporated herein by reference.

### FIELD

The present invention relates to a gas meter.

### BACKGROUND

A gas meter provided with a filter for trapping the dust in a gas has been proposed in the past. FIGS. 10A and 10B schematically show the internal structure of a conventional gas meters 200 and 300, respectively. A flow rate measurement unit 203 (303) with a built-in flow sensor is disposed in the gas meter 200 (300) having an inlet 201 (301) and an outlet 202 (302). The inlet 201 (301) is provided with a shutoff valve 204 (304) for shutting off the inflow of gas into the gas meter 200 (300). A filter 205 (305) is provided on the downstream side of the shutoff valve 204 (304). In FIG. 10A, a bag-shaped filter 205 is used that has a side surface portion along the inner wall of the gas meter and a bottom surface portion in the direction of blocking the flow path. In FIG. 10B, a filter 305 is used that is disposed in the direction of blocking the flow path. Thus, with a conventional gas meter, the filter 205 (305) is disposed so as to cover or block the gas flow path in order to trap dust more effectively.

Therefore, dust built up on the filter and the filter could end up being clogged. Also, if water enters the gas meter, and especially when the gas meter is installed in a cold region, this water may freeze and clog up the filter. When such clogging occurs, a problem is that this increases the pressure loss in the filter and the flow of gas through the gas meter is obstructed.

### SUMMARY

The present invention was conceived in light of the above situation, and it is an object thereof to provide a gas meter through which gas will flow even when the filter is clogged.

The gas meter according to one aspect of the present invention is a gas meter for measuring the flow rate of gas. The gas meter comprises: a gas meter body; a meter inlet through which the gas flows into the gas meter body; a meter outlet through which the gas flows out of the gas meter body; an inflow opening that communicates with the meter inlet and faces the inside of the gas meter body; a flow rate measurement module that measures the flow rate of the gas that flows in from the inflow opening and flows out from the meter outlet; and a filter device having a filter that removes dust from the gas that has flowed in from the inflow opening on the upstream side of the flow measurement module. The filter is disposed as to cover the inflow opening, and at least of a portion of the filter forms a plurality of filter partitions disposed spaced apart from one another toward the downstream side. At least two of the filter partitions have openings at different positions toward the downstream side.

With this configuration, even if the filter becomes clogged, it is possible to ensure a gas flow path through the opening provided in the filter partitions. Also, since a flow path along the filter partitions is provided between the openings provided at different positions, the dust trapping effect can be ensured.

At least two of the filter partitions should have an opening that is not covered by the filter, these being provided at different positions facing the downstream side, and filter partitions having openings at the same positions facing the downstream side may also be provided adjacent to each other.

In the gas meter according to the above aspect, two adjacent filter partitions of the plurality of filter partitions may have an opening that is not covered by the filter at different positions facing the downstream side.

With this configuration, in between adjacent filter partitions, a gas flow path is provided along the filter partitions from one opening up to the next opening, and this gives a good the dust trapping effect.

In the gas meter according to the above aspect, the gas meter may comprise a shutoff valve for opening and closing the inflow opening, wherein the filter device may have an accommodating unit for accommodating the shut-off valve.

With this configuration, the filter device can cover the inflow opening including the shutoff valve that opens and closes the inflow opening. The filter device can receive the gas flowing in from the inflow opening without leaking, and this also gives a good dust trapping effect.

In the gas meter according to the above aspect, the filter device may be disposed below the inflow opening, and the plurality of filter partitions may be disposed spaced apart from one another facing under the inflow opening.

With this configuration, in a gas meter installed such that the gas flows downward from an inflow opening disposed above, even if any moisture contained in the gas drips down, it can be trapped by the filter partitions, and the flow rate measurement module provided on the downstream side will not be affected by the water.

### BRIEF DESCRIPTION OF THE DRAWINGS

FIG. 1 is a cross section schematically showing the internal structure of a gas meter in an embodiment.

FIG. 2 is an overall oblique view of a support of the filter device in the embodiment.

FIG. 3A is a plan view of the support of the filter device in the embodiment, FIG. 3B is a side view of this support in the direction D1, FIG. 3C is a side view of this support in the direction D2, and FIG. 3D is a plan view of a tier portion of this support.

FIG. 4A is a diagram showing the filter partitions at the first and third tier portions in the embodiment, and FIG. 4B is a diagram showing the filter partitions at the second and fourth tier portions.

FIG. 5 is a schematic diagram showing the internal structure of the filter device attached to a gas meter in the embodiment.

FIGS. 6A and 6B are cross sections showing the schematic configuration of a sensor element in the embodiment.

FIG. 7A is an exploded oblique view of a flow rate measurement unit in the embodiment, FIG. 7B is an overall oblique view of the same, and FIG. 7C is a cross section of the same.

FIG. 8A is an exploded oblique view of another flow rate measurement unit in the embodiment FIG. 8B is an overall oblique view of the same, and FIG. 8C is a cross section of the same.

FIGS. 9A and 9B are graphs showing the dust test result for the gas meter according to the embodiment.

FIGS. 10A and 10B are cross sections schematically showing the internal structure of a conventional gas meter.

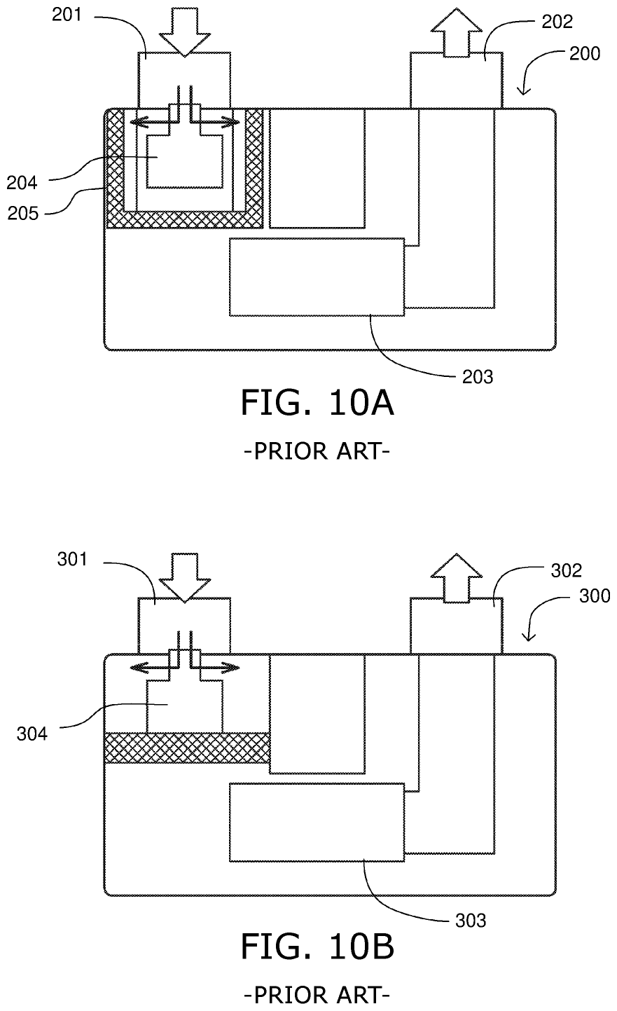

### DETAILED DESCRIPTION

An embodiment will now be described with reference to the drawings.

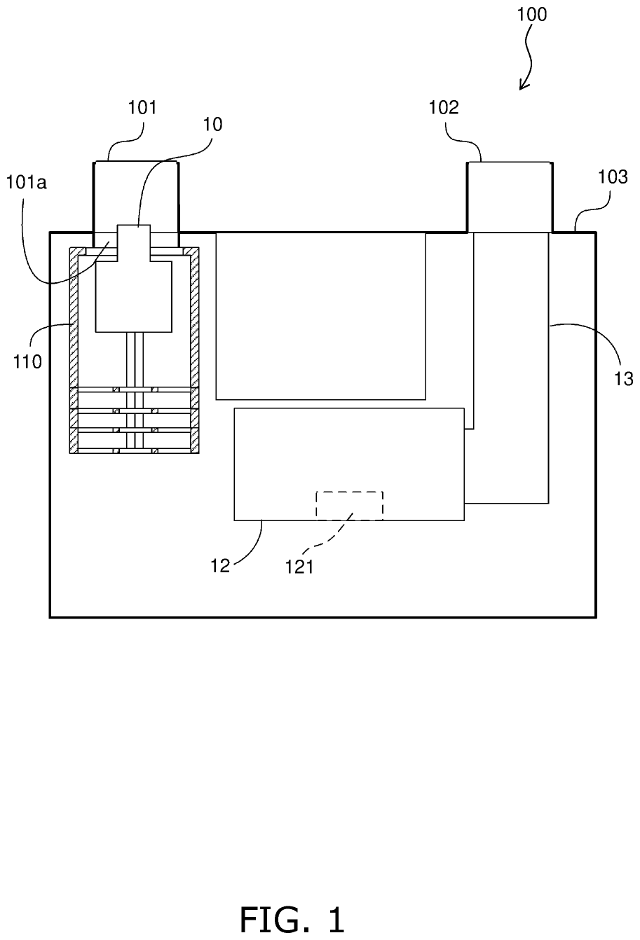

As shown in FIG. 1, a gas meter 100 according to the embodiment includes a shutoff valve 10 and a filter device 11 (only a support 110 thereof is shown in FIG. 1). The shutoff valve 10 opens and closes an inflow opening 101a which communicates with a meter inlet 101 of the gas meter 100 and faces the inside of a gas meter body 103. The filter device 11 covers the inflow opening 101a and removes dust from the gas flowing from the meter inlet 101. Since dust is removed by the filter device 11, the flow rate measurement unit 12 provided on the downstream side can measure the flow rate with high accuracy.

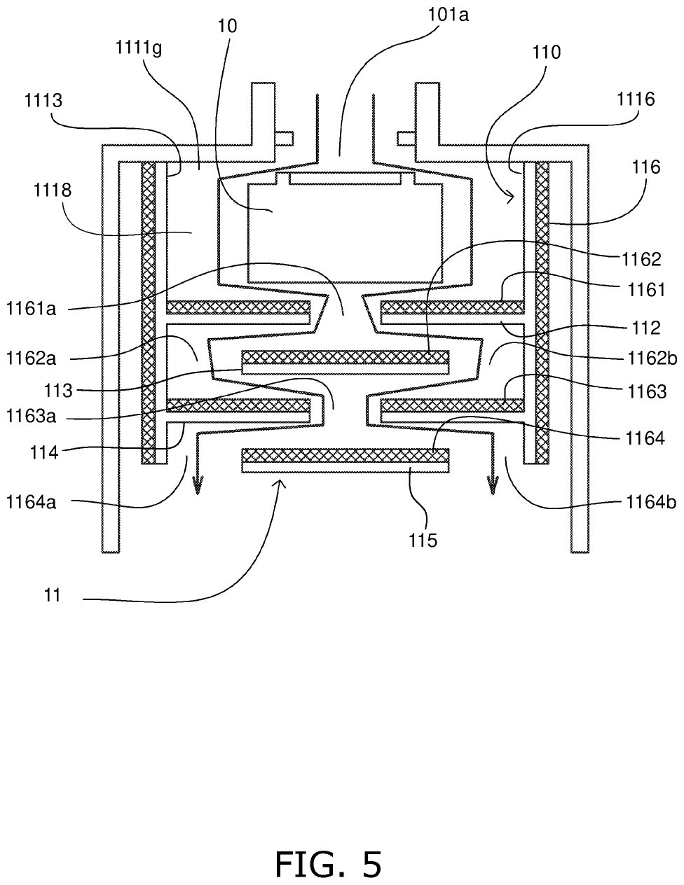

The filter device 11 has a support 110, and a filter 116 (see FIG. 5) supported by the support 110. The support 110 has a plurality of tier portions 112 to 115 stacked in a lower portion of the support 110. The filter 116 forms a plurality of filter partitions 1161 to 1164 supported on upper surfaces of the tier portions 112 to 115, respectively. The tier portions 112 to 115 are stacked in vertical direction and spaced apart from one another, and the same applies to the filter partitions 1161 to 1164. In the embodiment, as one example, the support 110 and the filter 116 have four tier portions and four filter partitions, respectively.

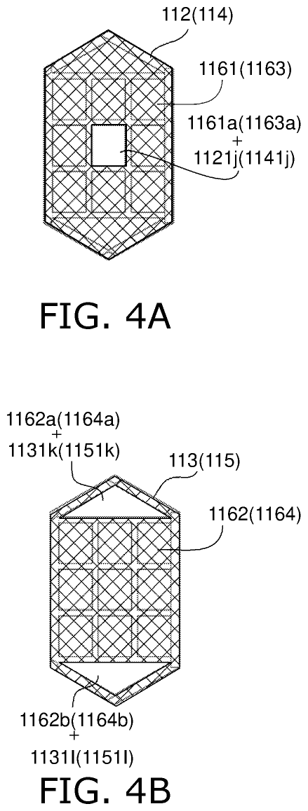

As shown in FIG. 4A, the first tier portion 112 has an opening 1121j that overlaps an opening 1161a of the first filter partitions 1161 supported thereon. The same applies to third tier portion 114 and filter partitions 1163. As shown in FIG. 4B, the second tier portion 113 has openings 1131k and 1131l that overlap openings 1162a and 1162b, respectively, of the filter partition 1162 supported thereon. The same applies to the fourth tier portions 115 and filter partitions 1164.

These openings 1161a, 1162a, 1162b, etc., are disposed between the adjacent tier portions, such as the tier portion 112 and the tier portion 113, so that they are at different positions when viewed in the vertical direction. In other words, at least two filter partitions have openings disposed at different positions from each other when viewed in the stacking direction. Especially, each opening of one filter partition (e.g., the opening 1161a of the first filter partition 1161) is disposed at different position from each opening of another filter partition adjacent to the one filter partition (e.g., the opening 1162a or 1162b of the second filter partition 1162) when viewed in the vertical direction or the stacking direction.

With this configuration of the filter device 11, as shown in FIG. 5, a part of the gas flowing in from the inflow opening 101a passes through a side portion of the filter 116 that covers the side surfaces of the support 110 and forms the side surfaces of the filter device 11 and flows to the downstream side. A part of the gas flowing in from the inflow opening 101a flows through the openings 1161a, etc., provided to the filter partitions 1161 to 1164 to the downstream side.

Therefore, even when the gas meter is installed in a cold clime and moisture contained in the gas freezes and clogs up the filter 116, pressure loss can be suppressed by the flow path going through the openings 1161a and the like, which makes possible more accurate measurement of the flow rate.

The embodiment will now be described in more detail with reference to the drawings.

FIG. 1 is a partial side cross section schematically showing the internal structure of the gas meter 100. The gas meter 100 has a meter inlet 101 and a meter outlet 102 provided on the surface (the upper surface in the figure) of the gas meter body 103. The shutoff valve 10, the filter device 11, and the flow rate measurement unit 12 are disposed inside the gas meter body 103. In the following description, “upper” and “lower” are defined on the basis of up and down in FIG. 1, but when the gas meter 100 is installed as shown in FIG. 1, these “upper” and “lower” coincide with upper and lower with respect to the vertical direction. The “upstream side” and the “downstream side” are defined with respect to the flow of gas from the meter inlet 101 toward the meter outlet 102.

The shutoff valve 10 is provided on the downstream side of the meter inlet 101. The shutoff valve 10 opens and closes the inflow opening 101a that communicates with the meter inlet 101 on its downstream side and opens into the interior of the gas meter body 103. The filter device 11 is provided so as to cover the inflow opening 101a and the shutoff valve 10. In FIG. 1, only the support 110 of the filter device 11 is shown, and the filter itself is not depicted.

The flow rate measurement unit 12 is disposed in the horizontal part of the gas meter body 103 at the downstream side with respect to the filter device 11. The flow rate measurement unit 12 is formed in a tubular shape having openings at both ends in the horizontal direction. The downstream opening of the flow rate measurement unit 12 is joined to the upstream opening of an L-shaped tubular member 13 that is joined to the upstream opening of the meter outlet 102.

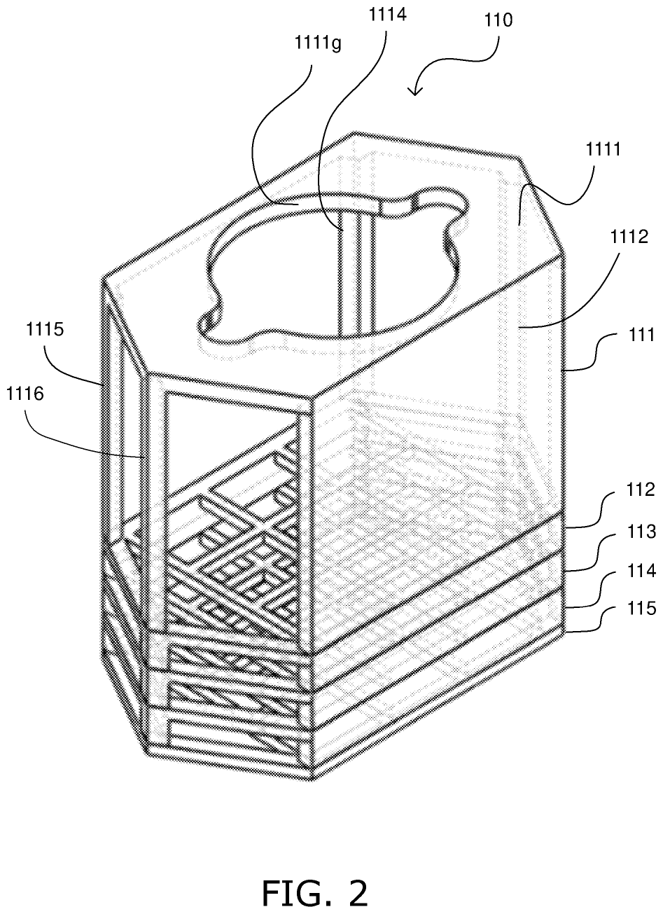

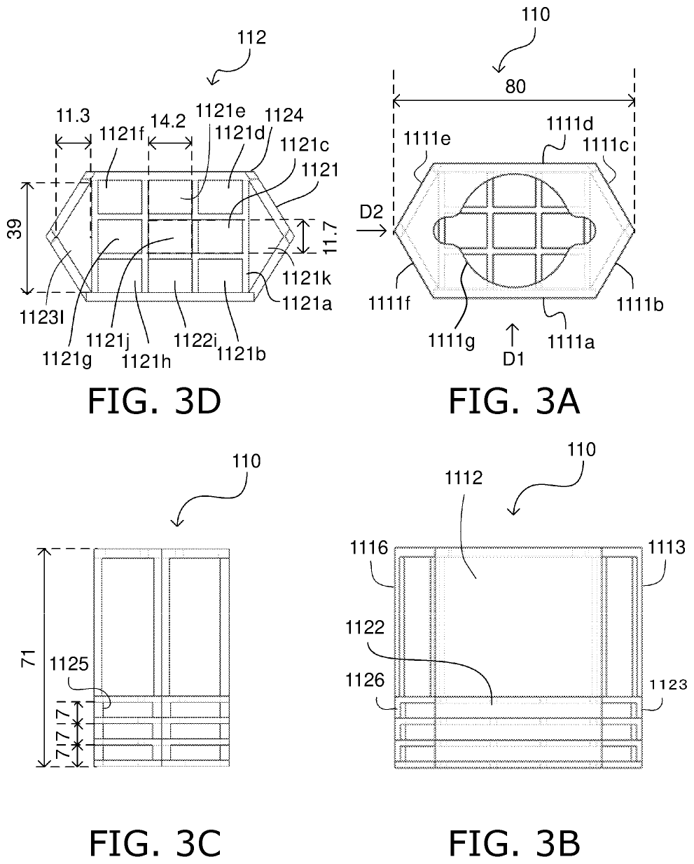

FIG. 2 is an oblique view of the outer shape of the support 110 of the filter device 11. FIG. 3A is a plan view of the support 110, FIG. 3B is a side view of the support 110 as seen in the D1 direction, and FIG. 3C is a side view of the support 110 as seen in the D2 direction. FIG. 3D is a plan view of the tier portion 112 of the support 110.

The support 110 can be formed from PLA (polylactic acid), for example, but the material is not limited to this.

The support 110 includes a main body 111 and tier portions 112, 113, 114, and 115. The support 110 has a substantially hexagonal prism shape of which a hexagonal upper surface 1111 is shortened in the D1 direction or is elongated in the D2 direction. That is, two opposite sides 1111a and 1111d facing in the D1 direction of the upper surface 1111 of the main body 111 are longer than the other four sides 1111b, 1111c, 1111e, and 1111f. An opening 1111g is provided in the center of the upper surface 1111. The opening 1111g has a substantially circular shape and bulges out at the two opposite positions in the D2 direction. A wall 1112 is formed on one side surface of the body 111 in the D1 direction. Columns 1113, 1114, 1115, and 1116 are formed at the four corners of the main body 111 (see also FIG. 2). Openings are formed between the columns 1113, 1114, 1115, and 1116 and between the columns 1113 and 1116 and the wall 1112.

Below the main body 111, the tier portions 112, 113, 114, and 115 are linked to form a hierarchical structure. As shown in the plan view of FIG. 3D, the tier portion 112 has a substantially hexagonal frame body 1121 having a lattice 1121a between two sides in the D1 direction. The tier portion 112 has multiple openings formed by the lattice 1121a. As one example, the lattice 1121a has nine rectangular openings 1121b, 1121c, 1121d, 1121e, 1121f, 1121g, 1121h, 1121i, and 1121j, and two triangular openings 1121k and 1121l are formed adjacent to the lattice 1121a in the D2 direction. A wall 1122 extends to one side surface in the D1 direction and downward from the frame body 1121 constituting the upper surface of the tier portion 112, and columns 1123, 1124, 1125, 1126 extend from the four corners. The tier portion 113 and the tier portion 114 are formed in the same shape as the tier portion 112, but the lowermost tier portion 115 is composed only of a frame body on the upper surface and does not have a wall or columns extending downward.

The filter device 11 is constituted by supporting a sheet-shaped filter 116 on the above-mentioned support 110 by adhesive bonding or the like. The filter 116 can be made from polyester, but the material is not limited to this. The filter 116 may have a weight of 210 g/m² and a thickness of 2.5 mm as one preferable example. The filter 116 can also be a porous resin membrane (such as Temisch manufactured by Nitto Denko).

The filter 116 is disposed so as to cover the side surfaces of the support 110, and is disposed so as to cover the upper surfaces of the tier portions 112, 113, 114, and 115. However, in the first tier portion 112 and the third tier portion 114, as shown in FIG. 4A, the central openings 1121j and 1141j of the lattice 1121a are not covered by the filter 116, and instead the openings 1161a and 1163a are provided to the filter 116 so as to coincide with the shape of the openings 1121j and 1141j, respectively. In the second tier portion 113 and the fourth tier portion 115, as shown in FIG. 4B, the two triangular openings 1131k and 1131l, and 1151k and 1151l are not covered by the filter 116, and instead the openings 1162a, 1162b, 1164a, and 1164b, which coincide with the shapes of the openings 1131k, 1131l, 1151k, and 1151l, respectively, are provided to the filter 116. Here, the filter 116 supported on the upper surfaces of the tier portions 112, 113, 114, and 115 constitutes the filter partitions 1161, 1162, 1163, and 1164. The filter partitions 1161, 1162, 1163, and 1164 supported on the upper surfaces of the tier portions 112, 113, 114, and 115 by the columns of the tier portions 112, 113, and 114 are disposed at a specific spacing from each other. Also, the filter 116 may be configured integrally or may be divided into a plurality of portions. In FIGS. 4A and 4B, the relation between the filter 116 and the columns 1113, etc., and the wall 1112 of the support 110 is not depicted.

FIG. 5 schematically shows a state in which the filter device 11 configured as above is attached to the gas meter 100. FIG. 5 shows a cross section cut at the central part passing through the columns 1113 and 1116, as viewed from the left side in FIG. 1. In a state in which the filter device 11 is attached to the downstream side of the meter inlet 101, the shutoff valve 10 is accommodated in the interior 1118 of the main body 111 of the support 110, and opens and closes the inflow opening 101a via the opening 1111g of the support 110. That is, the filter device 11 serves as a housing portion for the shutoff valve 10. The gas from the meter inlet 101 flows through the opened shutoff valve 10 and into the filter device 11, passes through the filter 116, and flows to the downstream side. A part of the gas that flows into the filter device 11 is allowed to pass through the opening 1161a of the filter partition 1161, and the opening 1121j of the tier portion 112, which is not covered by the filter 116, as indicated by the arrow. Subsequently, the gas passes through the openings 1162a and 1162b of the filter partition 1162 and the openings 1131k and 1131l of the tier portion 113. Furthermore, the gas passes through the opening 1163a of the filter partition 1163 and the opening 1141j of the tier portion 114. The gas then flows downstream through the openings 1164a and 1164b of the filter partition 1164 and the openings 1151k and 1151l of the tier portion 115.

With this configuration of the filter device 11, the dust that enters the gas meter 100 is trapped by the filter 116. Also, even if the filter 116 becomes clogged with dust or frozen moisture, pressure loss is suppressed and a good gas flow can be maintained. Also, because the openings of two adjacent filter partitions are disposed at different positions when viewed in the stacking direction (the vertical direction in FIG. 1), the gas flow path is formed in parallel to the upper surfaces of the tier portions 112, 113, 114, and 115, that is, in a direction intersecting the stacking direction. Therefore, a sufficient dust trapping effect can also be ensured for gas that passes through the openings 1161a, 1162a, 1162b, 1163a, 1164a, and 1164b. Also, even if moisture contained in the gas flowing in from the meter inlet 101 drips down, this moisture will be trapped by the filter 116 at one of the tier portions.

The dimensions of the various components are given in millimeters in FIGS. 3A, 3C, and 3D. The length of the support 110 in the D2 direction is 80 mm, the height (up and down direction in FIG. 1) is 71 mm, and the height of the tier portions 112, 113, and 114 is 7 mm. The rectangular openings 1121j and 1141j have long sides of 14.2 mm and short sides of 11.7 mm. The length of the bases of the triangular openings 1131k, 1131l, 1151k, and 1151l is 39 mm and the height is 11.3 mm.

The flow rate measurement unit 12 will be described. The flow rate measurement unit 12 includes a tubular flow tube member and a flow rate measurement module 121. The gas flowing through the main flow path formed inside the flow tube member is guided, either with or without being divided up, to the flow rate measurement module 121, where the flow rate of the gas is measured.

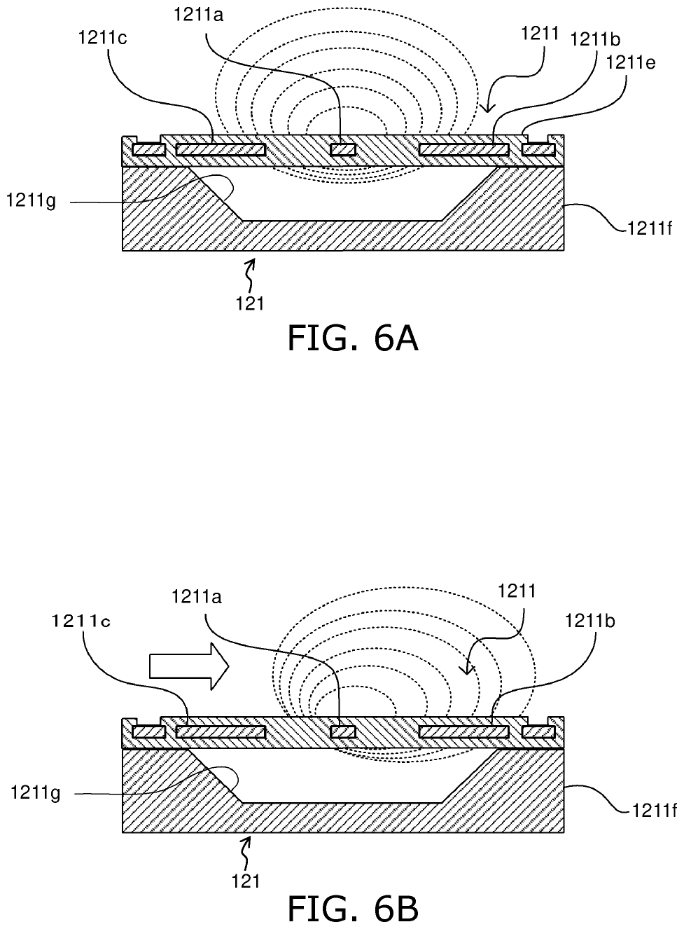

The flow rate measurement module 121 is provided with a sensor element 1211 (discussed below). As shown in FIGS. 6A and 6B, the sensor element 1211 has a configuration in which two thermopiles 1211b and 1211c are disposed sandwiching a micro-heater 1211a. The sensor element 1211 is a so-called thermal flow sensor. An insulating thin film 1211e is formed above and below the micro-heater 1211a and the two thermopiles 1211b and 1211c disposed side by side in a specific direction, and the thermopiles 1211b and 1211c and the insulating thin film 1211e are provided on a silicon base 1211f. Also, a cavity 1211g formed by etching or the like is provided in the silicon base 1211f below the micro-heater 1211a and the thermopiles 1211b and 1211c.

The micro-heater 1211a is a resistor formed of polysilicon, for example. In FIGS. 6A and 6B, the temperature distribution when the micro-heater 1211a generates heat is schematically shown by dotted ellipses. Ellipses closer to the inside have a higher temperature. When there is no fluid flow, the temperature distribution around the micro-heater 1211a is substantially uniform, as shown in FIG. 6A. On the other hand, when a fluid flows in the direction indicated by the arrow in FIG. 5B, for example, the surrounding air moves, so the temperature becomes higher on the downstream side than on the upstream side of the micro-heater 1211a. The sensor element 1211 outputs a value indicating the flow rate by utilizing this bias in the distribution of heater heat.

The output voltage ΔV of the sensor element 1211 is expressed by the following formula (1), for example.

ΔV=A(Tₕ−Tₐ)^{b}\sqrt{v_{f}} (1)

Here, Tₕ is the temperature of the micro-heater 1211a (the temperature of the end portion on the micro-heater 1211a side of the thermopile 1211b or 1211c). Tₐ is the lower temperature of the temperatures at the end of the thermopile 1211b on the far side from the micro heater 1211a (in FIG. 6A, the temperature at the left end of the thermopile 1211c, or the temperature at the right end of the left side thermopile 1211b, and in FIG. 6B, the temperature of the left-side thermopile 1211c, which is the upstream end). V_{f} is the average value of the flow velocity, and A and b are predetermined constants.

The circuit board 1212 of the flow rate measurement module 121 comprises a control unit (not shown) constituted by an IC (integrated circuit) or the like, and calculates the flow rate on the basis of the output of the flow rate measurement module 121.

The specific configuration of the flow rate measurement unit 12 will be described below.

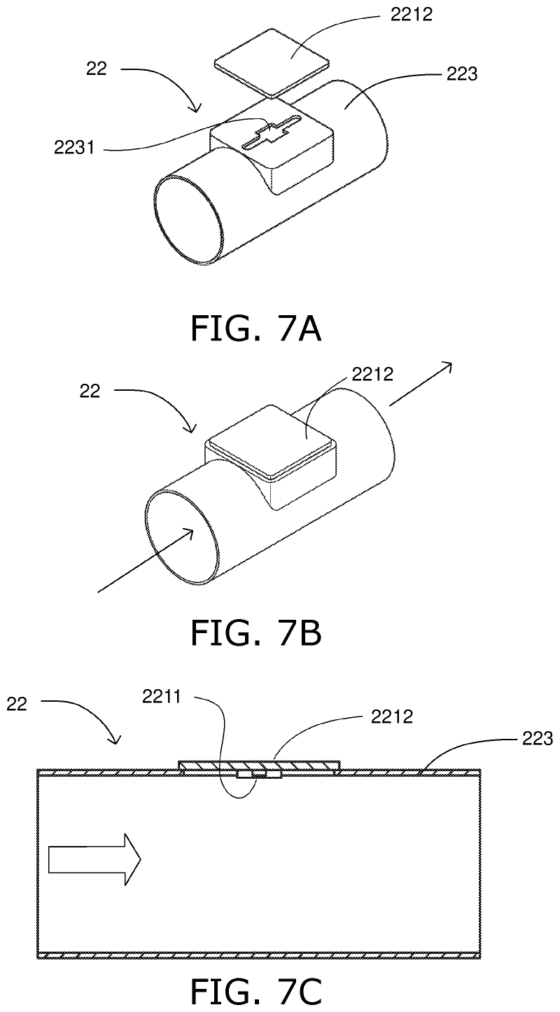

FIG. 7A is an exploded oblique view schematically showing a flow rate measurement unit 22, FIG. 7B is an oblique view of the flow rate measurement unit 22, and FIG. 7C is a cross section of the flow rate measurement unit 22. The flow rate measurement unit 22 comprises a sensor element 2211 and a circuit board 2212 on which the sensor element 2211 and a control unit (not shown) are mounted. A specific fluid flows through a flow tube member 223. One flow path portion 2231 is formed at the upper part of the flow tube member 223. The flow rate measurement unit 22 is fixed to the flow tube member 223 so that the sensor element 2211 is located inside the flow path portion 2231. The sensor element 2211 also comprises a micro-heater and thermopiles disposed flanking the micro-heater.

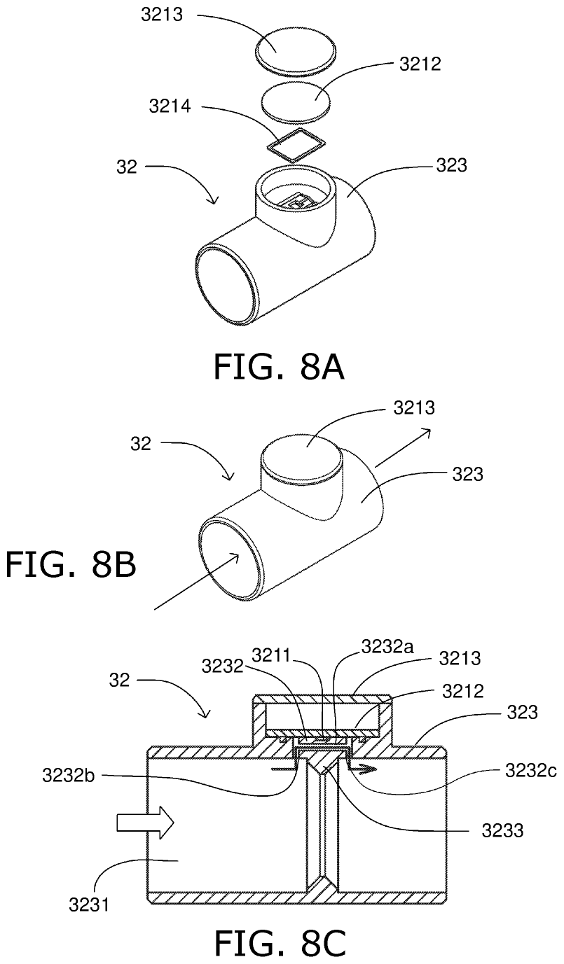

FIG. 8A is an exploded oblique view schematically showing a flow rate measurement unit 32, FIG. 8B is an oblique view of the flow rate measurement unit 32, and FIG. 8C is a cross section of the flow rate measurement unit 32. The flow rate measurement unit 32 has a flow tube member 323 comprising two flow path portions: a main flow path portion 3231 and an auxiliary flow path portion 3232. The flow rate measurement unit 32 comprises a disk-shaped circuit board 3212, a cover 3213 that covers the outer surface of the circuit board 3212, and a seal 3214 that affixes the circuit board 3212 and the flow tube member 323. As shown in FIG. 8C, the flow tube member 323 is equipped with two flow passage portions: the main flow passage part 3231 and the auxiliary flow path portion 3232. The main flow path portion 3231 is a tubular member. The auxiliary flow path portion 3232 is located to the side of the main flow path portion 3231, in the interior of which is formed an auxiliary flow path 3232a. A sensor element 3211 and a control unit (not shown) are mounted on the circuit board 3212. The sensor element 3211 is disposed so as to face the auxiliary flow path 3232a. The flow tube member 323 is provided with a restrictor 3233 in the vicinity of the auxiliary flow path portion 3232. When gas flows through the main flow path portion 3231, part of the gas flow is obstructed by the resistor 3233, goes through an inlet flow path 3232b and into the auxiliary flow path unit 3232, and merges with a main flow path portion 3231 from an outflow flow path 3232c.

The results of a dust test conducted with the gas meter according to this embodiment will be described. This dust test was conducted in accordance with 5.7 of EN14236, Immunity to Contaminants in Gas Stream.

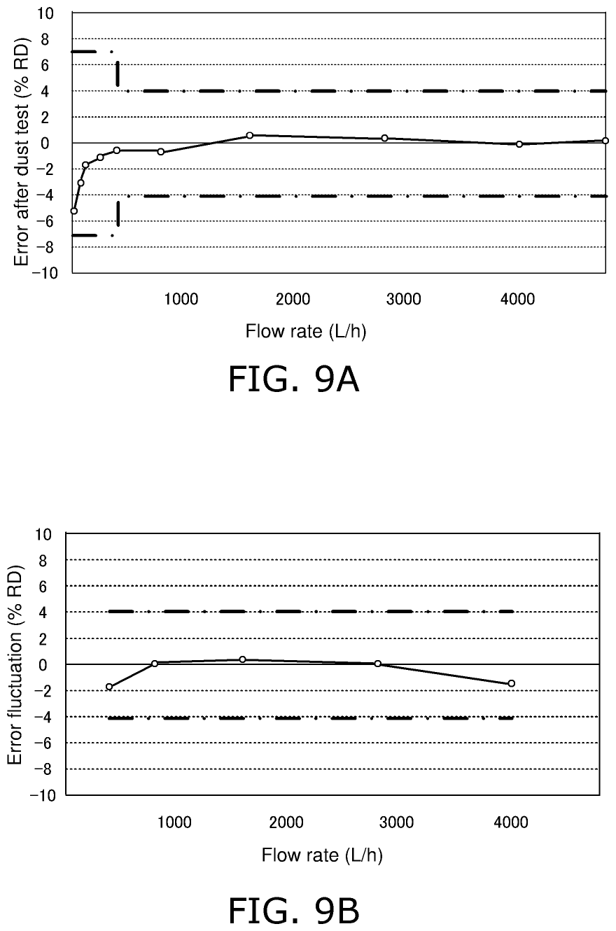

FIG. 9A is a graph of the relation between the flow rate and the error after the dust test, and FIG. 9B is a graph of the relation between the flow rate and fluctuation in the error. In FIG. 9A, the 2MPE (mean percentage error) is indicated by a one-dot chain line. As shown in FIG. 9A, the error after the test is within the range of 2MPE. The maximum error here is −5.1% RD. Also, in FIG. 9B, the ±2% RD is indicated by a one-dot chain line. As shown in FIG. 9B, the error fluctuation is within the range of ±2% RD, and the maximum fluctuation error is −0.8% RD.

The gas meter according to this embodiment satisfies the performance required for class 1 and 5 as defined in 5.7 of EN14236, has excellent dust removal, and allows the flow rate to be measured very accurately.

In addition, in order to allow a comparison of the constituent features of the present invention with the configuration in a working example, the constituent features of the present invention will be described by using the reference numerals in the drawings.

Invention 1

A gas meter (100) for measuring the flow rate of gas, comprising:

a gas meter body (103);

a meter inlet (101) through which the gas flows into the gas meter body (103);

a meter outlet (102) through which the gas flows out of the gas meter body (103);

an inflow opening (101a) that communicates with the meter inlet and faces the inside of the gas meter body (103);

a flow rate measurement module (121) that measures the flow rate of the gas that flows in from an inflow opening (101a) and flows out from the meter outlet (102); and

a filter device (11) having a filter (116) that removes dust from the gas that has flowed in from the inlet opening (101a) on the upstream side of the flow measurement module (121),
wherein the filter (116) is disposed as to cover the inlet opening (101a), at least a portion of the filter (116) forms a plurality of filter partitions (1161, 1162, 1163, 1164) disposed spaced apart from one another toward the downstream side, and at least two of the filter partitions (1161, 1162, 1163, 1164) have openings (1161a, 1162a, 1162b, 1163A, 1164a, 1164b) at different positions toward the downstream side.

### REFERENCE SIGNS LIST

11 . . . filter device
100 . . . gas meter
101 . . . meter inlet
102 . . . meter outlet
116 . . . filter
1161, 1162, 1163, 1164 . . . filter partition
1161a, 1162a, 1162b, 1163a, 1164a, 1164b . . . opening
121 . . . flow rate measurement module

1. A gas meter for measuring the flow rate of gas, comprising:
a gas meter body;
a meter inlet through which the gas flows into the gas meter body;
a meter outlet through which the gas flows out of the gas meter body;
an inflow opening that communicates with the meter inlet and faces the inside of the gas meter body;
a flow rate measurement module that measures the flow rate of the gas that flows in from the inflow opening and flows out from the meter outlet; and
a filter device having a filter that removes dust from the gas that has flowed in from the inflow opening on the upstream side of the flow measurement module,
wherein the filter is disposed as to cover the inflow opening, at least a portion of the filter forms a plurality of filter partitions disposed spaced apart from one another toward the downstream side, and at least two of the filter partitions have openings at different positions toward the downstream side.

2. The gas meter according to claim 1, wherein two adjacent filter partitions of the plurality of filter partitions have openings at different positions toward the downstream side.

3. The gas meter according to claim 1, comprising a shutoff valve for opening and closing the inflow opening,
wherein the filter device has a housing portion for accommodating the shut-off valve.

4. The gas meter according to claim 1, wherein the filter device is disposed below the inflow opening, and
the plurality of filter partitions are disposed spaced apart from one another downward the inflow opening.
